(19) United States
(12) Patent Application Publication
(10) Pub. No.: US 2004/0183426 A1
(43) Pub. Date: Sep. 23, 2004

(54) Deflection coil for deflection yoke

(76) Inventors: Yun-Ki Hong, Suwon-si (KR); Wun-Il Cho, Suwon-shi (KR)

Correspondence Address: GOTTLIEB RACKMAN & REISMAN PC, 270 MADISON AVENUE, 8TH FLOOR, NEW YORK, NY, 100160601

(21) Appl. No.: 10/652,948

(22) Filed: Aug. 28, 2003

(30) Foreign Application Priority Data
Mar. 18, 2003 (KR) 2003-16871

(51) Int. Cl. H01J 29/70

(52) U.S. Cl. 313/440

(57) ABSTRACT

The present invention relates generally to a deflection yoke for a color television, and more particularly to a deflection yoke, in which an auxiliary coil provided to a deflection coil that is a part of a deflection yoke is stably supported, thereby reducing the non-uniformity of assembly and controlling picture characteristics, thus greatly improving the quality of a cathode ray tube. The deflection coil includes a main coil comprising a screen portion, a neck portion and a body portion for connecting the screen portion to the neck portion, an auxiliary coil positioned at a center of the main coil, and connected to the neck portion at its lower ends to form a closed shape, and bridges for connecting an upper end of the auxiliary coil to the main coil to prevent movement of the auxiliary coil.

### BACKGROUND OF THE INVENTION

1. Field of the Invention

The present invention relates generally to a deflection yoke for a color television, and more particularly to a deflection yoke, in which an auxiliary coil provided to a deflection coil that is a part of a deflection yoke is stably supported, thereby reducing the non-uniformity of assembly and controlling picture characteristics, thus greatly improving the quality of a cathode ray tube.

2. Description of the Prior Art

Generally, the deflection principle of an electron beam emitted from an electron gun is applied to a cathode ray tube (hereinafter referred to as a “CRT”). Horizontal and vertical deflection magnetic fields should be applied to a neck of the CRT in order to emit the electron beam.

Coils for forming the deflection magnetic fields are horizontal and vertical deflection coils, which are disposed to be perpendicular to each other. The horizontal and vertical deflection coils and a ferrite core constitute a deflection yoke.

A general CRT includes a panel on which a fluorescent screen onto which three beams are emitted is formed, and a funnel which is attached to the end of the panel. An electron gun is mounted in the neck of the funnel to emit an electron beam. A deflection yoke is mounted on the funnel to deflect red, green and blue electron beams emitted from the electron gun.

A shadow mask, which is spaced from the fluorescent screen at a certain interval and has a plurality of throughholes for allowing an electron beam to pass therethrough, is fixedly mounted by being welded to a frame. Additionally, a stud pin that supports the frame is attached to the inner surface of the panel. An inner shield that shields and controls the path of the electron beam emitted from the electron gun is attached to the peripheral edge of the frame.

FIG. 1 is an example of a conventional CRT, which is a longitudinal section schematically showing a curved screen CRT.

As shown in FIG. 1, the conventional CRT is a curved screen CRT and includes a convex screen panel 1 that is curved outward at its front surface, a funnel 2 that is attached to the back end of the screen panel 1 using frit glass and maintains the inside of the CRT in a vacuum state, an electron gun 5 that is mounted in a neck 7 positioned at the rear of the funnel 2 and emits electron beams 4a, 4b and 4c, and a deflection yoke 6 that deflects the electron beams 4a, 4b and 4c emitted from the electron gun 5 in left, right, up and down directions.

The deflection yoke 6 includes a vertical deflection coil 12 that vertically deflects the electron beams 4a, 4b and 4c by applying a vertical deflection magnetic field to the electron beams 4a, 4b and 4c emitted from the electron gun 5 of the CRT, a horizontal deflection coil (not shown) that horizontally deflects the electron beams 4a, 4b and 4c by applying a horizontal deflection magnetic field to the electron beams 4a, 4b and 4c emitted from the electron gun 5 of the CRT, a separator 11 that precisely separates the horizontal deflection coil from the vertical deflection coil 12 and electrically insulates the horizontal deflection coil from the vertical deflection coil 12, and a ferrite core 13 that enhances magnetic fields applied by the horizontal deflection coil and vertical deflection coil 12, as shown in FIG. 2.

The horizontal deflection coil is assembled around the inner surface of the separator 11 with the horizontal deflection coil divided into upper and lower portions, and the vertical deflection coil 12 is assembled around the outer surface of the separator 11 with the vertical deflection coil 12 divided into left and right portions.

That is, the horizontal deflection coil adheres to the inner surface of the separator 11 to form a horizontal deflection magnetic field, and the vertical deflection coil 12 adheres to the outer surface of the separator 11 to form a vertical deflection magnetic field.

In this case, the horizontal deflection coil and the vertical deflection coil 12 constituting one pair are assembled to the inner and outer surfaces of the separator 11 to be perpendicular to each other, respectively, after they are individually manufactured on a production line, and apply horizontal and vertical deflection magnetic fields to the electron beams emitted from the electron gun 5, respectively.

A ferrite core 13, which comprises two cores around the outer surface of the separator 11 and is constructed to have a roughly cylindrical shape, is assembled to surround the vertical deflection coil 12, and functions to strengthen the vertical deflection magnetic field.

The deflection yoke 6 for a CRT, constructed as described above, forms respective deflection magnetic fields by applying a current having a preset waveform to the horizontal deflection coil and the vertical deflection coil 12.

The deflection yoke 6 generally allows red, green and blue electron beams emitted from the different positions of an electron gun to converge to the same position of a screen by adjusting the distribution of the respective deflection coils, and simultaneously ensures that the outermost upper and lower raster lines form straight lines each having a preset length.

If the red, green and blue electron beams deflected by the horizontal deflection coil and the vertical deflection coil 12 are not focused at the precise position of the screen, misconvergence, by which the color quality of a picture projected on the screen is lowered, occurs. Hitherto, a deflection coil having an auxiliary coil has been used to prevent such misconvergence.

That is, misconvergence, which means that the red, green and blue electron beams displayed on the screen of the CRT diverge, can be corrected by forming the auxiliary coil in the deflection coil.

FIG. 3 is a front view of a conventional deflection coil in which an auxiliary coil is formed. As shown in FIG. 3, the deflection coil 20 includes a neck portion 21 that is brought into contact with the neck side end of a separator, a screen portion 22 that is brought into contact with the screen side end of the separator, a main coil 23 that connect the screen portion 22 to the neck portion 21, and an auxiliary coil 24 that is positioned at the center of the main coil 23 and connected to the neck portion 21 at its lower ends to form a closed shape.

The auxiliary coil 24 is formed into an inverted “U” shape, and is formed to be connected in series to the main coil 23.

When a certain voltage is applied to the deflection coil 20 constructed as described above, some of the applied voltage is applied to the auxiliary coil 24 and then a certain magnetic field is formed. Accordingly, a pin magnetic field generated in the case where there is no the auxiliary coil 24 is converted into a barrel magnetic field, so that the misconvergence can be corrected.

Additionally, the voltage is applied to a portion where the main coil 23 of the deflection yoke 20 for the CRT are disposed, and therefore back electromotive force caused by a main magnetic field is not generated.

The deflection coil 20 integrally including the auxiliary coil 24 have an independent construction in that the auxiliary coil 24 is connected to the main coil 23 at its lower ends and therefore formed into a closed shape. However, there is no additional fastening means to hold the two corners of the upper end of the auxiliary coil 24, so that the auxiliary coil 24 is deformed and therefore its characteristics may be affected during the time after the auxiliary coil 24 is formed in the deflection coil 20 and before the deflection coil 20 is assembled to the deflection yoke.

That is, the auxiliary coil 24 is connected to the main coil 23 at only its lower ends, but is not fixed to the main coil 23 at its upper end. Accordingly, the shape and position of the auxiliary coil 24 are not stable, so that the auxiliary coil 24 cannot maintain its initial winding state and is often deformed.

As described above, there occurs a problem that characteristics of the deflection coil 20 are badly affected in the case where the auxiliary coil 24 is deformed.

Accordingly, hitherto, there has been used a method of fixing the auxiliary coil 24 by attaching a tape 25 to the auxiliary coil 24, as shown in FIG. 4.

However, the method of fixing the auxiliary coil 24 using the tape 25 is problematic in that a process of attaching or detaching the tape 25 must be carried out, so that it is inconvenient and requires much labor.

Additionally, the method is problematic in that the cost of materials is additionally increased due to the tape 25.

### SUMMARY OF THE INVENTION

Accordingly, the present invention has been made keeping in mind the above problems occurring in the prior art, and an object of the present invention is to provide a deflection coil, which is provided with an auxiliary coil maintaining its initial winding state, thereby minimizing the deformation of the auxiliary coil and consequently reducing the non-uniformity of assembly.

Another object of the present invention is to provide a deflection coil, in which its local winding structure is controlled, thereby controlling picture characteristics and consequently improving the quality of a CRT.

A further object of the present invention is to provide a deflection coil, in which an additional process of attaching or detaching a tape is unnecessary, thereby reducing the number of processes and consequently decreasing the cost of materials.

In order to accomplish the above object, the present invention provides a deflection coil for a deflection yoke, including a main coil comprising a screen portion, a neck portion and a body portion for connecting the screen portion to the neck portion, an auxiliary coil connected to the main coil to adjust characteristics of the main coil, and bridges for connecting the auxiliary coil to the main coil to prevent movement of the auxiliary coil.

In order to accomplish the above object, the present invention provides a deflection coil for a deflection yoke, including a main coil comprising a screen portion, a neck portion and a body portion for connecting the screen portion to the neck portion, an auxiliary coil positioned at a center of the main coil, and connected to the neck portion at its lower ends to form a closed shape, and bridges for connecting an upper end of the auxiliary coil to the main coil to prevent movement of the auxiliary coil.

The auxiliary coil is connected to the main coil at its lower ends to form an inverted “U” shape, and the bridges are formed to be connected to corners of the upper end of the auxiliary coil.

Additionally, the bridges are symmetrically formed beside both side portions of the auxiliary coil, and the bridges each form an angle of 100 to 180 degrees with the upper end of the auxiliary coil.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an example of a conventional CRT, which is a longitudinal section schematically showing a curved screen CRT;

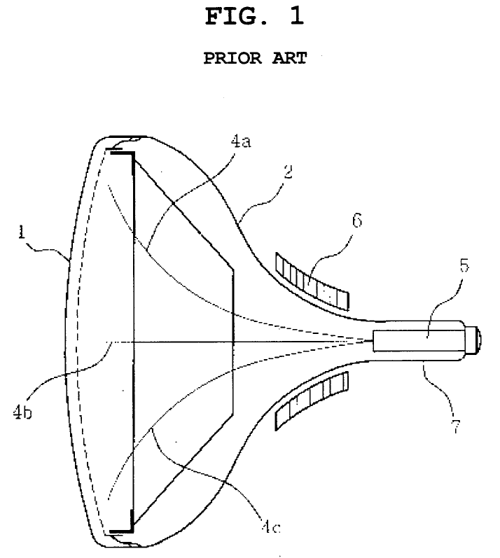

FIG. 2 is a front view of a conventional deflection yoke;

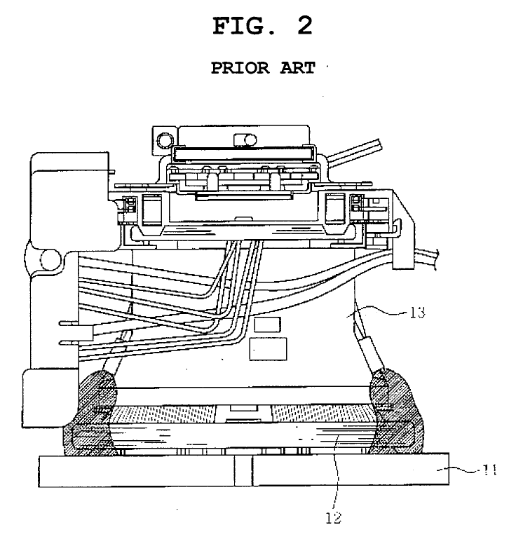

FIG. 3 is a front view of a deflection coil in which a conventional auxiliary coil is formed;

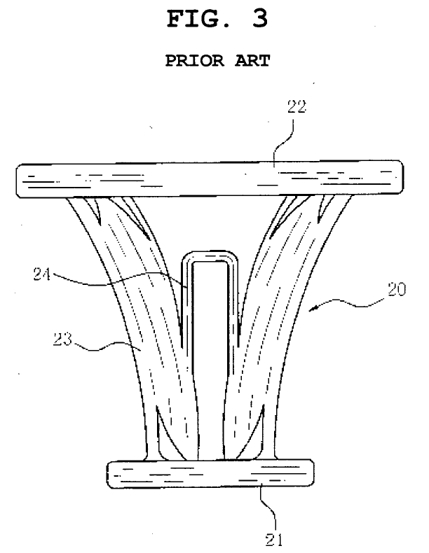

FIG. 4 is a front view of a deflection coil in which a tape is attached to the conventional auxiliary coil;

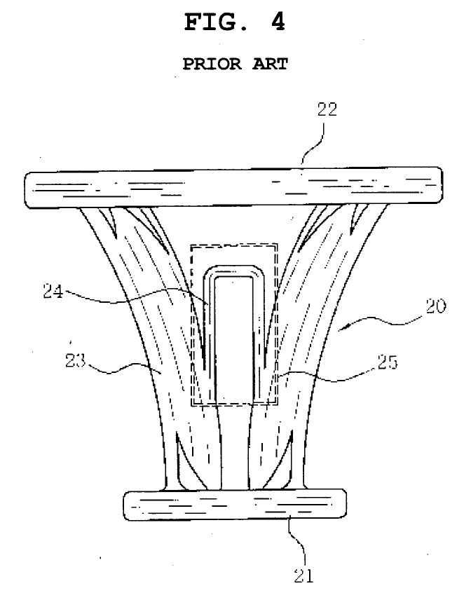

FIG. 5 is a front view of a deflection coil according to the present invention; and

FIG. 6 is a front view of a general screen.

### DESCRIPTION OF THE PREFERRED EMBODIMENTS

Reference now should be made to the drawings, in which the same reference numerals are used throughout the different drawings to designate the same or similar components.

Hereinafter, a deflection coil for a deflection yoke according to embodiments of the present invention will be described in detail with reference to the attached drawings.

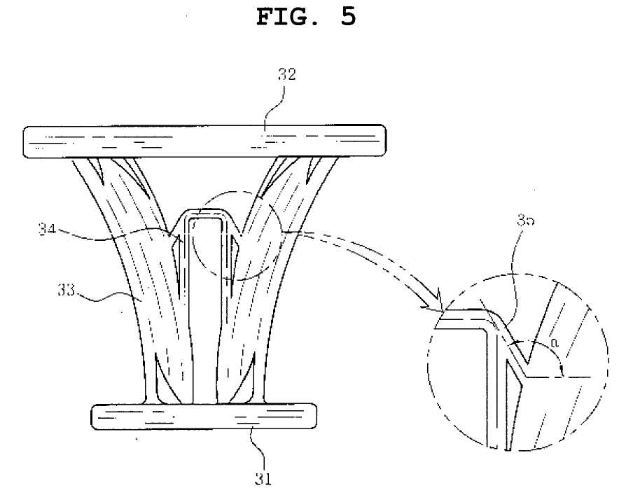

The deflection coil, as shown in FIG. 5, includes a neck portion 31 that is brought into contact with the neck side end of a separator, a screen portion 32 that is brought into contact with the screen side end of the separator, a main coil 33 that connects the screen portion 32 to the neck portion 31, an auxiliary coil 34 that is connected to the main coil 33 to adjust characteristics of the main coils 33, and bridges 35 that connects the auxiliary coil 34 to the main coil 33 to prevent the auxiliary coil 34 from being moved.

The auxiliary coil 34 is positioned at the center of the main coil 33, and formed to be connected to the neck portion 31 at its lower ends in order to form a closed shape.

The auxiliary coil 34 is connected to the main coil 33 at its lower ends, is formed into an inverted “U” shape and is connected in series to the main coil 33. When a certain voltage is applied to the deflection coil, some of the applied voltage is applied to the auxiliary coil 34 and then a certain magnetic field is formed. Accordingly, a pin magnetic field generated in the case where there is no the auxiliary coil 34 is converted into a barrel magnetic field, so that the misconvergence can be corrected.

The bridges 35 are formed in the deflection coil to prevent the auxiliary coil 34 from being moved. The bridges 35 are symmetrically formed beside the auxiliary coil 34, and, more particularly, formed beside the upper side portions of the auxiliary coil 34.

That is, in the deflection coil of the present invention, there are formed the bridges 35 connected to the main coil 33 at the two corners of the upper end of the auxiliary coil 34 which has a construction obtained by being connected to the main coils 33 at its lower ends and formed into a closed shape.

Accordingly, the bridges 35 connect the auxiliary coil 34 to the main coil 33 to prevent the auxiliary coil 34 from being moved and to fix the auxiliary coil 34.

Accordingly, in the deflection coil provided with the bridges 35 according to the present invention, the bridges 35 fix the auxiliary coil 34 during the time after the auxiliary coil 34 is formed in the deflection coil and before the deflection coil is assembled to the deflection yoke, so that the movement of the auxiliary coil 34 is prevented, and therefore the auxiliary coil 34 is not deformed at the time of assembling the deflection yoke.

As described above, some good effects are achieved by the prevention of the deformation of the auxiliary coil 34.

Firstly, the characteristics of the deflection yoke are prevented from being badly affected by the deformation of the auxiliary coil 34.

Accordingly, the deformation of the auxiliary coil 34 is prevented, so that the characteristics of the deflection yoke are improved, and therefore the quality of a CRT in which the deflection yoke is mounted is improved.

Accordingly, the auxiliary coil 34 that is formed in the deflection coil maintains its initial winding state and then the deformation of the auxiliary coil 34 is minimized, so that the auxiliary coil 34 is prevented from being non-uniformly assembled.

That is, the assembly process of the deflection yoke is simplified, and additionally time required to assemble the deflection yoke can be reduced.

Meanwhile, the angles α of the bridges 35, that is, angles α formed between the upper end of the auxiliary coil 34 and the bridges 35 that connect the main coil 33 to the two corners of the upper end of the auxiliary coil 34, are in the range of 100 to 180 degrees.

Further preferably, as shown in FIG. 5, the bridges 35 are disposed in the angular range of 120 to 135 degrees, which is an example according to an embodiment of the present invention, and the angular range is not limited to this example.

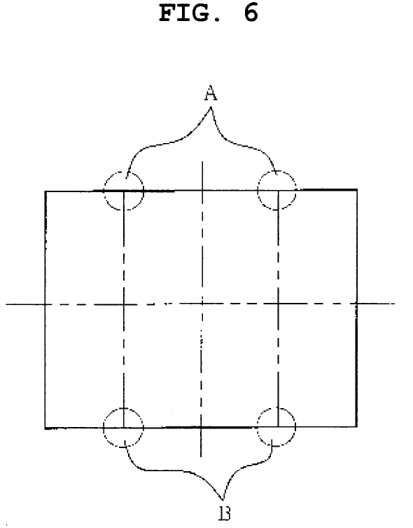

In the deflection coil of the present invention, the independently constructed auxiliary coil 34 controls a local magnetic potential at the center of the main coil 34 using the bridges 35, so that the characteristics of local pictures of a center A of each of the two half portions of the upper end of the whole screen and a center B of each of the two half portions of the lower end of the whole screen and other portions which are affected by other effects can be controlled, as shown in FIG. 6.

Additionally, the bridges 35 prevent the movement of the auxiliary coil 34, so that the tape 25 attached to the auxiliary coil 34 in a conventional assembly process of the deflection yoke is unnecessary.

Accordingly, processes of attaching the tape 25 to the auxiliary coil 34 and detaching the tape 25 from the auxiliary coil 34 are unnecessary, which make a manufacturing process convenient and allows labor to be reduced.

Additionally, since the tape 25 is unnecessary, the cost of materials is not increased due to the tape 25.

As described above, the present invention provides a deflection coil, in which bridges connected to a main coil are formed beside the upper side portions of an independently constructed auxiliary coil, thereby minimizing the non-uniformity of assembly of the auxiliary coil resulting from the deformation of the auxiliary coil.

That is, the local structure of the deflection coil is stably maintained and supported, so that the auxiliary coil is prevented from being non-uniformly assembled.

Additionally, the movement of the auxiliary coil is prevented, so that its initial winding state is maintained and the deformation of a product is minimized. Accordingly, the auxiliary coil controls a local magnetic potential of the center of the main coil, so that the characteristics of local pictures at the centers of the half portions of the upper and lower ends of the whole screen and other portions which are affected by other effects can be controlled, thereby improving the quality of a CRT.

Additionally, processes of attaching the tape to the auxiliary coil and detaching the tape from the auxiliary coil carried out in the prior art are unnecessary, which makes a manufacturing process convenient and allows labor to be reduced compared to the prior art.

Accordingly, since the process of taping is unnecessary, the number of processes can be reduced. Additionally, since the tape is not added, the cost of materials can be reduced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A deflection coil for a deflection yoke, comprising:
a main coil comprising a screen portion, a neck portion and a body portion for connecting the screen portion to the neck portion;
an auxiliary coil connected to the main coil to adjust characteristics of the main coil; and
bridges for connecting the auxiliary coil to the main coil to prevent movement of the auxiliary coil.

2. The deflection coil for a deflection yoke according to claim 1, wherein the bridges are symmetrically formed beside both side portions of the auxiliary coil.

3. The deflection coil for a deflection yoke according to claim 2, wherein the bridges each form an angle of 100 to 180 degrees with an upper end of the auxiliary coil.

4. A deflection coil for a deflection yoke, comprising:
a main coil comprising a screen portion, a neck portion and a body portion for connecting the screen portion to the neck portion;
an auxiliary coil positioned at a center of the main coil, and connected to the neck portion at its lower ends to form a closed shape; and
bridges for connecting an upper end of the auxiliary coil to the main coil to prevent movement of the auxiliary coil.

5. The deflection coil for a deflection yoke according to claim 4, wherein the auxiliary coil is connected to the main coil at its lower ends to form an inverted “U” shape, and the bridges are formed to be connected to corners of the upper end of the auxiliary coil.

6. The deflection coil for a deflection yoke according to claim 5, wherein the bridges are symmetrically formed beside both side portions of the auxiliary coil.

7. The deflection coil for a deflection yoke according to claim 6, wherein the bridges each form an angle of 100 to 180 degrees with the upper end of the auxiliary coil.
